(19) United States
(12) Patent Application Publication
(10) Pub. No.: US 2007/0121992 A1
(43) Pub. Date: May 31, 2007

(54) Speaker and electronic device equipped with the speaker

(75) Inventor: Toru Nakagawa, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/544,715

(22) Filed: Oct. 10, 2006

(30) Foreign Application Priority Data
Nov. 30, 2005 (JP) 2005-346090

(51) Int. Cl. H04R 9/06

(52) U.S. Cl. 381/396; 381/433

(57) ABSTRACT

According to one embodiment, a speaker comprises a frame, a drive source attached to the frame, which converts an electric signal into mechanical vibration, a diaphragm coupled to the drive source, which emits an acoustic wave corresponding to the mechanical vibration, and an attachment structure coupled to a predetermined portion (field unit attachment face) of the frame, which has a flange at a position remote from the predetermined portion. The attachment structure has predetermined compliance in a direction of vibration of the diaphragm, and which has predetermined stiffness in a direction substantially orthogonal to the direction of vibration of the diaphragm.

### CROSS-REFERENCE TO RELATED APPLICATIONS

This application is based upon and claims the benefit of priority from Japanese Patent Application No. 2005-346090, filed Nov. 30, 2005, the entire contents of which are incorporated herein by reference.

### BACKGROUND

1. Field

One embodiment of the invention relates to improvement of an attachment mechanism of a speaker converting an electric signal into mechanical vibration and, more particularly, to a structure in which when a speaker successively generating great vibration at an actual use is attached to a cabinet having elements (high-definition display device, high-frequency components, etc.) which do not like vibration, vibration (sound pressure) is hardly transmitted to the cabinet or the elements provided in the cabinet.

2. Description of the Related Art

In a conventional speaker structure, a frame and a flange are formed in a mechanically coupled state. Vibration occurring at a diaphragm is transmitted to the frame. For this reason, the vibration is also transmitted to the flange serving as a fixing portion of the cabinet (see a speaker structure of Jpn. Pat. Appln. KOKAI Publication No. 10-023596 or Jpn. Pat. Appln. KOKAI Publication No. 2002-159091).

In Jpn. Pat. Appln. KOKAI Publication No. 10-023596, a magnetic circuit is inserted into a resin casing and a distal end portion of the resin frame is engaged with an opening portion of the resin casing to fix the magnetic circuit inside the resin casing, a breakage portion which can be broken with a circumferential force is provided on a flange of the resin casing, a flange portion at a top of the breakage portion is welded on the resin frame. In Jpn. Pat. Appln. KOKAI Publication No. 2000-159091, injection molding is executed by using thermoplastic resin to mold a dome portion, a voice coil junction, a cone portion, and a frame-attached outer peripheral portion as one body.

When the speaker having such a structure is mounted, it is considered that a damping member (rubber-formed, donut-shaped bushing, etc.) having internal loss to the vibration is attached to the flange portion and the speaker is fixed to the cabinet with a screw passing through the damping portion, in order to restrict transmission of the vibration to the cabinet. In this case, the flange portion of the speaker is mechanically screwed on the cabinet via the damping portion.

One of the objects of the present invention is to prevent the vibration generated at the speaker from being easily transmitted even if the speaker is firmly fixed to the cabinet.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a cross-sectional view illustrating a structure of a speaker according to a first embodiment of the invention;

FIG. 2 is a perspective view illustrating an outer appearance of the speaker according to the first embodiment of the invention;

FIG. 3 is an illustration of an effect of a frame opening portion covered under feet of a spring structure in the structure of FIG. 2;

FIG. 4 is an illustration of an outer appearance of an electronic device (slim-type digital TV equipped with the speaker of FIG. 1) according to the first embodiment of the invention; and

FIG. 5 is an illustration of the manner of providing the speaker of FIG. 1 inside the device of FIG. 4.

### DETAILED DESCRIPTION OF THE INVENTION

Various embodiments according to the invention will be described hereinafter with reference to the accompanying drawings. In general, according to one embodiment of the invention, a speaker comprises a frame, a drive source attached to the frame, which converts an electric signal into mechanical vibration, a diaphragm coupled to the drive source, which emits an acoustic wave corresponding to the mechanical vibration, and an attachment structure coupled to a predetermined portion of the frame, which has a flange at a position remote from the predetermined portion, which has predetermined compliance in a direction of vibration of the diaphragm, and which has predetermined stiffness in a direction substantially orthogonal to the direction of vibration of the diaphragm.

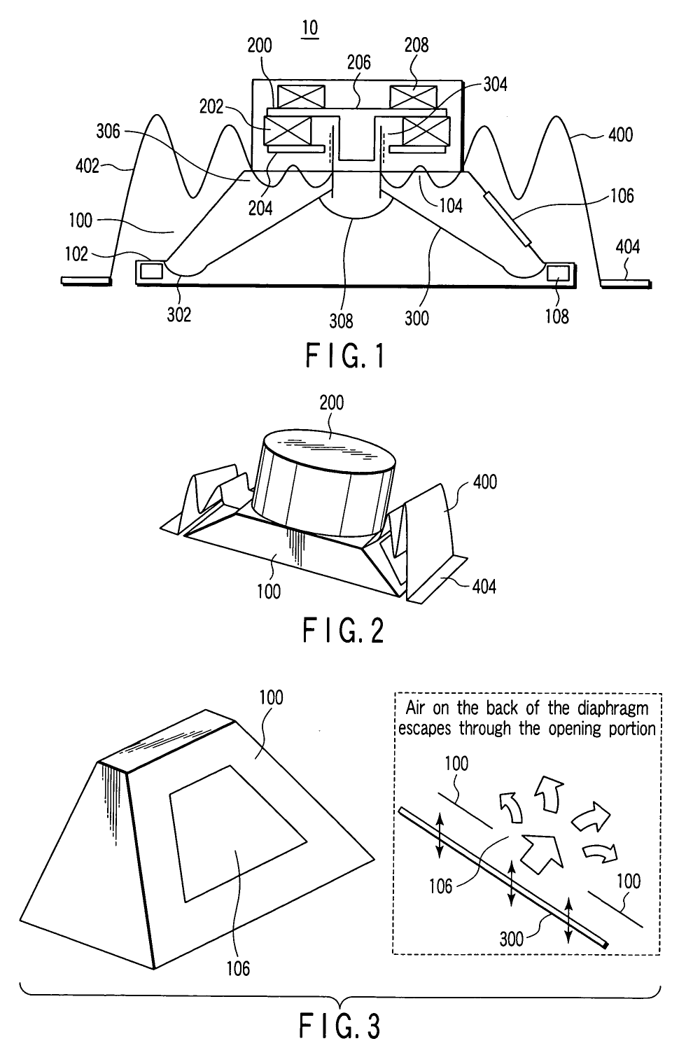

FIG. 1 is a cross-sectional view illustrating a structure of a speaker 10 according to the embodiment of the invention. The speaker 10 is roughly composed of a frame portion 100, a field unit 200, a vibration system (300-306), and an attachment structure (400-404).

The vibration system (300-306) is composed of a conical (or ellipsoidal or rectangular) diaphragm 300, an edge 302, a voice coil 304 wound round a voice coil bobbin, a damper (spider) 306 and a center cap 308. The attachment structure (400-404) is formed by integrally molding a spring structure 400 obtained by shaping a flat plate into wave, feet 402, and a flange 404, in plastic (thermoplastic resins such as PP, PE, PS, ABC, etc.)

The field unit 200 is composed of a main magnet 202, a top plate 204, a pole piece (center pole) 206 integrated with a bottom plate, and a cancel magnet 208 (and a magnet cover if necessary).

The frame portion 100 is shaped in a deep dish having a trapezoidal cross-section. A hole is formed at a center of a bottom surface (field unit attachment surface) 104. The voice coil bobbin passes through the hole. The field unit 200 is bonded and/or screwed (or welded) to the field unit attachment surface 104 to coaxially arrange the through hole and the pole piece 206. The frame portion 100 comprises an opening portion 106 which releases a back pressure when the diaphragm 300 generates a great-amplitude low tone.

At the frame portion 100, the voice coil bobbin is positioned by the damper 306 such that the voice coil 304 is arranged in a magnetic gap between the pole piece 206 and the top plate 204 so as to be in no contact therewith. In addition, an outer peripheral portion of the edge 302 is bonded to a frame outer peripheral portion 102 such that the voice coil 304 does not rub against the pole piece 206 or the top plate 204 even if the diaphragm 300 vibrates at great amplitude. After that, a gasket 108 is attached to the frame outer peripheral portion 102 so as to catch an outer peripheral portion of the edge 302.

The frame portion 100 can be formed of metal (iron plate, etc.) or plastic (thermoplastic resin such as PP, PE, PS, ABS, etc.) If the frame portion 100 is formed of metal, the attachment structure (400-404) is fixed to the frame portion 100 by screwing the field unit 200 on the field unit attachment surface 104 so as to catch a part of the attachment structure (i.e. flat plate portions between waveform spring structures 400 at right and left sides of the field unit 200 in FIG. 1).

If the frame portion 100 is formed of plastic (thermoplastic resin) similarly to the attachment structure (400-404), the frame portion 100 and the attachment structure (400-404) can be molded with the same material (thermoplastic resin such as ABS, etc.) In this case, mold die is relatively complicated, but molding the frame and the attachment structure at low costs can be expected at mass production.

The frame outer peripheral portion 102 and the flanges 404 are structurally separated, irrespective of the materials of the frame portion 100 and the attachment structure (400-404), and irrespective of integral molding or separate formation of the frame portion 100 and the attachment structure (400-404).

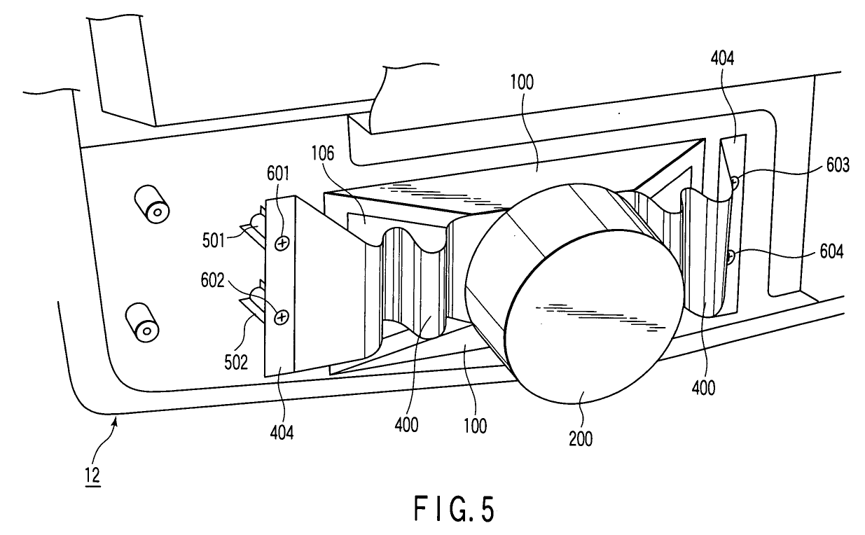

In the speaker 10 shown in FIG. 1, the diaphragm 300 is supported by the edge 302 and damper 306 having spring characteristics and can conduct piston vibration in a longitudinal direction of the pole piece 206. This vibration is generated by the voice coil 304 which flows a current in a direction orthogonal to a magnetic field formed at the field unit 200. The diaphragm 300 can be vibrated by flowing a current to the voice coil 304. The gasket 108 has effects of preventing peeling of the edge 302, filling a gap between the frame portion 100 and the cabinet (12 in FIG. 4 or FIG. 5), and leading the acoustic energy (particularly low audio-frequency energy) generated at the diaphragm 300. In this embodiment, the effects of filling the gap and restricting transmission of the vibration generated at the frame can be achieved by forming the gasket 108 with, for example, a sponge structure such as urethane foam.

In the structure of the speaker 10 shown in FIG. 1, the vibration energy generated at the voice coil 304 operates the diaphragm 300 such that the electric input is converted into acoustic energy. At this time, the diaphragm 300 vibrates with the frame portion 100 serving as an axis. For this reason, energy (reaction of diaphragm vibration) opposing the energy of the diaphragm 300 is generated at the frame 100. Initially, this energy should escape to the cabinet, etc. (12 in FIG. 4 or FIG. 5) by the strictly fixed flanges 404. In this case, however, the vibration energy propagates to the structure (display device, electronic circuit, etc.) including the cabinet and causes abnormal sounds and the other influences (for example, rocking a coil of a tuner, etc. and unbalancing the tuning, etc.).

To prevent this, the propagation can be decreased by using damping members (rubber bush, etc.) as the flanges 404. However, if a loss amount of the damping members is too great, the vibration (particularly low-frequency vibration) of the diaphragm 300 is reduced (i.e. the movement of the frame 100 becomes great, the diaphragm 300 that should be originally vibrated is not operated by air resistance, instead the frame 100 is operated, and the energy is absorbed by the damping members). The amount of the acoustic conversion is thereby radically decreased.

If the damping members become hard (i.e. the loss amount is reduced), the propagation amount of the vibration to the cabinet becomes increased and the object of preventing the generation of abnormal sounds and the influence to the inner components (tuner coil, etc. in the above example) cannot be thereby achieved. Thus, the characteristics of the damping members need to be tuned in accordance with the performance of the speaker. As the tuning generally depends on the material characteristics, tuning the details is difficult.

On the other hand, in the structure shown in FIG. 1 in which the spring structure 400 particularly has a large surface by plastic molding, the frame 100 is fixed if the diaphragm 300 is in a small amplitude. If the amplitude of the diaphragm 300 becomes great, the vibration of the frame 100 is absorbed by the spring structure 400 and the propagation of the vibration to the flanges 404 can be reduced. They can be controlled in accordance with the material (plastic, etc.) of the spring structure 400, etc., the spring structure (number of waves, pitch of the waves, shape/size such as the height of waves, etc.), and the thickness and/or width of the spring structure, etc. Thus, an ideal vibration restriction effect can be produced in accordance with the specifications of the speaker 10.

In addition, by the integral molding of plastic (thermoplastic resin) having not rigidity similarly to a metal but flexibility to a certain degree, it is also possible to reduce an influence from displacement in the relationship in attachment position between the cabinet and the gasket 108 which can be hardly provided thereat originally in this structure (i.e. the relationship between a position of an attachment boss 501 of the cabinet 12 and a position of an attachment 601 of the flange 404, in an example shown in FIG. 5). In other words, the speaker 10 having the structure shown in FIG. 1 can be easily positioned when it is attached to the cabinet 12, etc. (The spring structure can be flexibly moved. Even if the attachment aperture of the flange 404 is slightly displaced, the position of the attachment aperture can be easily shifted to the position of the attachment boss 501, etc.)

FIG. 2 is a perspective view illustrating an outer appearance of the speaker 10 according to the embodiment of the invention. The speaker 10 is formed by integrally molding the flame 100 and flanges 404, and the spring structure 400 provided therebetween with plastic (thermoplastic resin). In this case, the spring structure 400 supports the field unit 200 and the frame 100 against the flanges 404, and the spring structure 400 is provided to be wide (such that stiffness in a direction orthogonal to the direction of vibration of the diaphragm 300 becomes great). The rolling of the flame 100 and the field unit 200 (i.e. wobbling in the lateral direction, at the vibration and the attachment) can be thereby restricted.

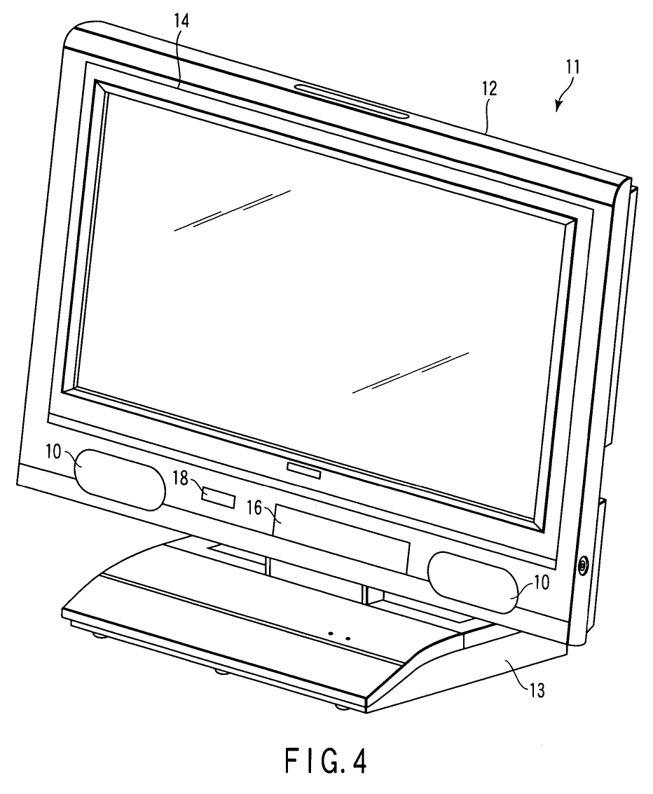

In addition, the faces of the wide spring structure 400 relieve the air vibration directly radiated from a back of the diaphragm 300 through an opening portion (106 in FIG. 1 or FIG. 3) formed on the frame 100, relieve the influences of the air vibration on the back of the diaphragm to the other members (i.e. influences to electronic components inside the cabinet which are sensitive to the vibration), properly control the back pressure of the diaphragm 300, and contributes to the restriction of the vibration at a great amplitude (i.e. Q damp at the lowest resonant frequency of the speaker).

In the structure of the speaker 10 shown in FIG. 2, the conventional speaker structure having the flanges in an extension of both sides of the frame is denied, the flanges 404 are separated from the frame 100 and bonded to the speaker body (field unit 200 and frame 100) via the spring structure 400.

The field unit 200 and the frame 100 cannot be separated for the purpose of holding and vibrating the diaphragm 300. Thus, the spring structure 400 is bonded to the structure (200 and 100) in which they are bonded, and the flanges 404 are formed on the side ends of the spring structure 400 to fix the speaker body to the cabinet, etc. This structure can be integrally molded by forming the frame 100, the spring 400 and the flanges 404 by plastic molding.

FIG. 3 is an illustration of an effect of the frame opening portion 106 covered under feet of the spring structure in the structure of FIG. 2. The opening portion 106 is provided to form an escape route of the air on the back of the diaphragm when the diaphragm 300 vibrates.

If the opening portion 106 is not provided, the vibration of the diaphragm 300 is restricted by the air pressure of the space formed by the back face of the diaphragm and the frame 100 and, particularly, a great amplitude of the air vibration in a low audio frequency cannot be formed. In this embodiment, a cover (including the spring structure 400 and the feet 402) preparing an escape route of the air is formed over the opening portion 106 at a certain interval. Therefore, the opening portion 106 has an effect of relieving the direct radiation of the air vibration through the opening portion 106 and restricting the influences to the other members. In addition, the spring structure 400 and/or the feet 402 become obstacles to the airflow of the great-amplitude acoustic wave generated at a very great low-sound input. Thus, air control of certain degree is applied to the back face of the diaphragm 300 via the opening portion 106, and an effect of reducing load on the damper 306 and the edges 302 supporting the diaphragm 300 can be thereby obtained.

FIG. 4 is an illustration of an outer appearance of the electronic device (slim-type digital TV equipped with the speaker 10 of FIG. 1) according to the embodiment of the invention. In FIG. 4, a television receiver 11 (i.e. electronic device equipped with the speaker 10 according to the invention) mainly comprises a slim cabinet 12 formed in a substantially square shape as an device body, and a stand 13 which supports the cabinet 12 upright. A display area of an image display unit 14 composed of, for example, a flat liquid-crystal display panel (high-definition display panel: a precision device to which application of great vibration is undesirable), etc. is exposed on the front face of the cabinet 12. A pair of speakers 10, an operation portion 16, a photoreceiver 18 for receiving operation information transmitted from a remote controller, etc. are arranged on the cabinet 12.

The stand 13 is formed in a substantially thin box shape such that one of plains thereof, i.e. a bottom plate is placed on a predetermined table (not shown) installed horizontally. A support member projecting upwardly from a substantially central portion of a top plate opposite to the bottom plate placed on the table is coupled to a back face of the cabinet 12. The stand 13 thereby supports the cabinet 12 upright. The stand 13 can contain a HDD unit (and/or DVD recorder unit) 20 to be described later. A plurality of operation buttons for controlling operations such as recording, reproduction, and stop, etc. of the HDD unit (and/or DVD recorder unit) 20 are arranged on a portion of the top plate of the stand 13 which projects to the front side from the position of the cabinet 12. The HDD unit (and/or DVD recorder unit) 20 is also one of electronic devices to which application of great vibration from the speaker is undesirable. The television receiver comprises a tuner which receives minute-level high-frequency signals. This tuner is also an electronic device to which application of great vibration from the speaker is undesirable.

FIG. 5 illustrates an example of attachment of the speaker 10 of FIG. 1 inside the device (cabinet 12) of FIG. 4. In the structure of the speaker 10, there is a condition for the attachment to the cabinet 12 in the direction of gravity. The frame 100 cannot be strictly screwed on the cabinet 12, from the viewpoint of the prevention of propagation of the vibration. In addition, as described with reference to FIG. 1, since the field unit 200 is composed of heavy components such as the magnet, top plate, poll piece, etc., the field unit 200 is comparatively heavy. For this reason, if the speaker of FIG. 5 is attached to attachment bosses 501, 502, . . . of the cabinet 12 via attachment apertures of the flanges 404 by screws 601 to 604, the spring structure 400 needs not be inclined due to the weight of the field unit 200.

The above requirement is satisfied by the manner of attachment shown in FIG. 5 if the direction of gravity is a lateral direction of FIG. 5. In other words, in the speaker attached to the cabinet 12 as shown in FIG. 5, since the spring structure 400 of FIG. 5 has great compliance at waveform portions thereof in the direction of vibration of the diaphragm 300 of FIG. 1, the acoustic vibration on the field unit attachment surface (104) of the frame 100 is rarely transmitted to the flanges 404. In addition, the spring structure 400 has stiffness enough to support the weight of the speaker (at least the field unit 200) in a direction substantially orthogonal to the direction of vibration of the diaphragm 300 in FIG. 1 (“substantially orthogonal” represents permitting a certain degree of αat 90°±α°: longitudinal direction of the spring structure 400 in FIG. 5). Therefore, the field unit 200 is not inclined by its own weight. At this time, if the gasket 108 of FIG. 1 slightly abuts on a part of the cabinet 12 of FIG. 5, the inclination occurs more hardly.

In addition, the spring structure 400 extending from the flange 404 to the attachment face (104) of the field unit 200 can easily be elastically deformed by great compliance at this part of the spring structure 400. For this reason, even if screw apertures of the left flange 404 of FIG. 5 are shifted to the right or left side from the positions of the attachment bosses 501 and 502 after the right flange 404 of FIG. 5 is screwed at attachment bosses (not shown) of the cabinet 12 with screws 603 and 604, this shift can easily be corrected (by shifting the positions of the screw apertures of the flange 404 to the positions of the bosses with a slight force).

In the above embodiment, the frame 100 is formed of plastic (thermoplastic resin) from the viewpoint of implementing integral molding with the spring structure 400. However, if they are not integrally molded, the frame 100 may be formed of a metal frame of an iron plate, etc. In this case, the spring structure 400, the feet 402 and the flanges 404 are produced in advance, separately from the frame 100. When the field unit 200 is attached to the frame 100, the middle part of right and left spring structures 400 may be sandwiched between the field unit attachment face 104 of the frame 100 and the field unit 200 and thereby fixed. The fixing method can be arbitrarily selected from bonding, welding, screwing, etc.

<Advantages of the Embodiment of this Invention>

<1>The frame and the flange, and the spring Structure provided therebetween can be integrally molded with plastic;

<2>The spring structure can restrict the rolling of the frame and the field unit (i.e. wobbling occurring at the vibration and attachment) by supporting the unit field and the frame against the attached flange and having great width;

<3>The face of the wide spring structure can relieve the direct radiation of air vibration from the back face of the diaphragm through the opening portion formed on the frame and can relieve influences of the air vibration from the back face of the diaphragm to the other units; and

<4>Since the structure <3>also contributes to controlling the back pressure of the diaphragm and restricting the vibration occurring at the great amplitude, the structure can bring about a loudness effect in low sound pressure output characteristics (the restriction of vibration is small at a low-volume level since the diaphragm amplitude is small, while the restriction of vibration is great at a high-volume level).

<Short description of the speaker (FIG. 1) according to the embodiment of the present invention>

The flange 404 and the frame 100 are separated from each other, and the spring-like structure 400 is provided between the flange 404 and the coupling unit 104 on the speaker main unit (200 and 300) side to restrict propagation of the vibration occurring at the speaker main unit (200 and 300) to the flange 404 (speaker).

In the spring structure 400 provided between the flange 404 and the speaker main unit (200 and 300), the flange 404, the feet 402, the spring structure 400 and the frame 100 are integrally molded with plastic (speaker frame).

The present invention is not limited to the embodiment described above but the constituent elements of the invention can be modified in various manners at present or in future, on the basis of the technology available at that time, without departing from the spirit and scope of the invention. For example, the spring structure according to the invention is provided at the dynamic speaker using cone paper as the diaphragm in FIG. 1. However, the spring structure according to the invention is provided at the frame of the speaker using a flat diaphragm. In addition, the principle of operation of the diaphragm in the speaker to which the spring structure according to the invention can be applied may employ not only a force generated by flowing a current to a conductor in the magnetic field (dynamic speaker in a broad sense), but also Coulomb force (capacitor speaker) or a piezoelectric element (crystal speaker). However, since a dynamic speaker can output a greater vibration power, the spring structure according to the invention may be generally applied to the dynamic speaker from the viewpoint of restricting a harm caused by propagating the vibration of the speaker to the cabinet.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A speaker comprising:
a frame;
a drive source attached to the frame, which converts an electric signal into mechanical vibration;
a diaphragm coupled to the drive source, which emits an acoustic wave corresponding to the mechanical vibration; and
an attachment structure coupled to a predetermined portion of the frame, which has a flange at a position remote from the predetermined portion, which has predetermined compliance in a direction of vibration of the diaphragm, and which has predetermined stiffness in a direction substantially orthogonal to the direction of vibration of the diaphragm.

2. The speaker according to claim 1, wherein a peripheral portion of the frame in the vicinity of or in contact with a peripheral edge of the diaphragm is remote from the flange, and not to the peripheral portion but the flange is mechanically fixed to a cabinet to which the speaker is to be attached.

3. The speaker according to claim 1, wherein
the attachment structure comprises a spring structure and feet together with the flange;
the spring structure is shaped in a waveform and has a first end portion and a second end portion on both ends thereof, and the first end portion is coupled to the predetermined portion of the frame;
each of the feet has a one-side end and an other-side end, the one-side end is coupled to the second end portion of the spring structure, and the other-side end is coupled to the flange; and
the predetermined compliance is set in accordance with the waveform shape of the spring structure and a material of the spring structure.

4. The speaker according to claim 2, wherein
the attachment structure comprises a spring structure and feet together with the flange;
the spring structure is shaped in a waveform and has a first end portion and a second end portion on both ends thereof, and the first end portion is coupled to the predetermined portion of the frame;
each of the feet has a one-side end and an other-side end, the one-side end is coupled to the second end portion of the spring structure, and the other-side end is coupled to the flange; and
the predetermined compliance is set in accordance with the waveform shape of the spring structure and a material of the spring structure.

5. The speaker according to claim 1, wherein an opening portion is provided at a portion of the frame opposite to the diaphragm, and a portion of the attachment structure spaced apart from the opening portion covers the opening portion.

6. The speaker according to claim 2, wherein an opening portion is provided at a portion of the frame opposite to the diaphragm, and a portion of the attachment structure spaced apart from the opening portion covers the opening portion.

7. The speaker according to claim 3, wherein an opening portion is provided at a portion of the frame opposite to the diaphragm, and a portion of the attachment structure spaced apart from the opening portion covers the opening portion.

8. The speaker according to claim 4, wherein an opening portion is provided at a portion of the frame opposite to the diaphragm, and a portion of the attachment structure spaced apart from the opening portion covers the opening portion.

9. The speaker according to claim 3, wherein the spring structure, the feet, and the flange are integrally molded with plastic or thermoplastic resin.

10. The speaker according to claim 4, wherein the spring structure, the feet, and the flange are integrally molded with plastic or thermoplastic resin.

11. The speaker according to claim 1, wherein the attachment structure and the frame are integrally molded with plastic or thermoplastic resin.

12. The speaker according to claim 2, wherein the attachment structure and the frame are integrally molded with plastic or thermoplastic resin.

13. The speaker according to claim 3, wherein the attachment structure and the frame are integrally molded with plastic or thermoplastic resin.

14. The speaker according to claim 4, wherein the attachment structure and the frame are integrally molded with plastic or thermoplastic resin.

15. The speaker according to claim 5, wherein the attachment structure and the frame are integrally molded with plastic or thermoplastic resin.

16. The speaker according to claim 6, wherein the attachment structure and the frame are integrally molded with plastic or thermoplastic resin.

17. The speaker according to claim 7, wherein the attachment structure and the frame are integrally molded with plastic or thermoplastic resin.

18. The speaker according to claim 8, wherein the attachment structure and the frame are integrally molded with plastic or thermoplastic resin.

19. An electronic device comprising a cabinet having a speaker-attached portion and a speaker attached to the speaker-attached portion,
the speaker comprising
a frame;
a drive source attached to the frame, which converts an electric signal into mechanical vibration;
a diaphragm coupled to the drive source, which emits an acoustic wave corresponding to the mechanical vibration; and
an attachment structure coupled to a predetermined portion of the frame, which has a flange at a position remote from the predetermined portion, which has predetermined compliance in a direction of vibration of the diaphragm, and which has predetermined stiffness in a direction substantially orthogonal to the direction of vibration of the diaphragm,
the predetermined compliance being selected by flexibility with which the mechanical vibration of the drive source is restricted from being transmitted to the frame,
hardness of the predetermined stiffness being selected such that an entire weight of the drive source or the speaker can be supported,
the flange being fixed to the speaker-attached portion so as to apply gravity in a direction of the predetermined stiffness.
